(19) United States
(12) Patent Application Publication
(10) Pub. No.: US 2007/0028411 A1
(43) Pub. Date: Feb. 8, 2007

(54) Air Pressure Based System For Clearing Vehicle Windshields

(75) Inventor: Jacinto Manuel Silva, Gainesville, FL (US)

Correspondence Address: JACINTO SILVA, 3825 SW 91 DRIVE, GAINSVILLE, FL, 32608, US

(73) Assignee: Jacinto Manuel Silva, Gainesville, FL (US)

(21) Appl. No.: 11/161,521

(22) Filed: Aug. 6, 2005

(51) Int. Cl. B60S 1/54

(52) U.S. Cl. 15/316.1

(57) ABSTRACT

This is a system for continuously clearing vehicle windshields of water and debris using an air pressure based system. The system uses the air pressure generated by the vehicle's own movement as well as backup air pressure generated by a pressure generation motor when the vehicle is moving slowly or stopped. The system applies the air pressure externally along the base of the windshield and is mixed with hot air from the engine to clear the air pressure vents and windshield of ice and snow.

Current windshield clearing systems use mechanical means to clear windshields. The system for which a patent is sought would use an air pressure based system to clear windshields.

The pressure would be generated in two ways: 1) from the wind pressure generated while the car is moving and 2) by a pressure generation motor when external movement-based air-pressure has decreased beyond a minimum. The air is collected at the front of the vehicle using ducts and channeled through increasingly smaller ducts until it reaches the windshield. The channeling to smaller ducts is done to distribute the air and increase air pressure. At the windshield, the air pressure is delivered through a thin vent that stretches the entire lower base of the windshield. To clear the windshield of ice and keep the vent clear, the system can also inject hot air from the engine into the windshield ducts using a heat blower.

What is claimed is:

1. The windshield can be cleared of water and debris without obstructing the driver's view with windshield wiper arms and blades.

2. All parts of the windshield would be cleared continuously. This provides a continuous clear view for the driver. With wiper-based windshield clearing systems, each part of the windshield is cleared only when a wiper passes over each part of the windshield and the driver's view is obstructed periodically.

3. By injecting heat into the air ducts, ice and snow can be melted more quickly from the windshield than heating the windshield from the inside as in conventional systems.

4. Injecting heat though the pressure ducts insures that ice would not create a blockage in the ducts and prevent it from functioning to clear the windshield.
